(19) United States
(12) Patent Application Publication
(10) Pub. No.: US 2025/0229321 A1
(43) Pub. Date: Jul. 17, 2025

(54) BED MESH COMBINATION DEVICE, BED MESH COMBINATION METHOD, AND BED MESH MANUFACTURED USING THE SAME

(71) Applicant: Guangzhou Lianrou Machinery & Equipment Co., Ltd, Guangzhou City (CN)

(72) Inventors: Zhiliang TAN, Guangzhou City (CN); Rongfeng PAN, Guangzhou City (CN); Zhiming TAN, Guangzhou City (CN); Jie LIANG, Guangzhou City (CN)

(73) Assignee: Guangzhou Lianrou Machinery & Equipment Co., Ltd, Guangzhou City (CN)

(21) Appl. No.: 18/761,878

(22) Filed: Jul. 2, 2024

(30) Foreign Application Priority Data
Jan. 11, 2024 (CN) 202410044011.3

(51) Int. Cl. B21F 27/16; A47C 27/06; A47C 27/07

(52) U.S. Cl. CPC B21F 27/16; A47C 27/062; A47C 27/07

(57) ABSTRACT

A bed mesh combination device includes a first loading mechanism, a feeding mechanism, a second loading mechanism, and a combination mechanism. In a first direction, the first feeding mechanism transports the first spring strings of a set length to a first position, and the feeding mechanism transfers the first spring strings from the first position to a second position. At the second position, the first spring strings are parallel to the first direction. The second loading mechanism can reciprocate in the first direction, so as to continuously arrange the second spring string back and forth in the first direction at the second position. At the second position, there is one first spring string between two adjacent sections of the second spring string. The combination mechanism welds or sews the first spring strings at the second position and the adjacent second spring string to form a bed mesh.

### CROSS-REFERENCE TO RELATED APPLICATION

This application is based on and claims the benefit of priority from Chinese Patent Application No. 202410044011.3, filed on 11 Jan. 2024, which are incorporated by reference herein in their entirety.

### TECHNICAL FIELD

The present disclosure relates to the technical field of bed mesh manufacturing, and in particular, to a bed mesh combination device, a bed mesh combination method, and a bed mesh manufactured using the same.

### BACKGROUND

Independent bagged spring bed mesh is usually manufactured by combining a plurality of rows of spring strings in parallel. Existing bed mesh combination device mainly has two combination modes: glue bonding and ultrasonic welding. The disadvantages of glue bonding lie in large amount of hot melt adhesive, high cost, and non-environmental protection. In the related art, the bed mesh device using ultrasonic welding involves cross-welding every two adjacent spring strings. However, this approach has the disadvantage of requiring numerous welds, leading to lower production efficiency.

### SUMMARY

In order to solve at least one of the above technical problems, the present disclosure provides a bed mesh combination device, a bed mesh combination method, and a bed mesh using the same. The technical solutions adopted are as follows.

The bed mesh combination device provided by the present disclosure includes a first loading mechanism, a feeding mechanism, a second loading mechanism, and a combination mechanism. The first loading mechanism is configured to transport first spring strings of a set length to a first position in the bed mesh combination device in a first direction parallel to a length direction of a cloth bag of the first spring strings. The feeding mechanism is configured to transfer the first spring strings from the first position to a second position in the bed mesh combination device, and at the second position, the first spring strings are parallel to the first direction. The second loading mechanism is configured to transport a second spring string and is capable of reciprocating in the first direction in the bed mesh combination device, so as to continuously arrange the second spring string back and forth in the first direction at the second position, and at the second position, there is one first spring string between two adjacent sections of the second spring string. The combination mechanism is configured to weld or sew each of the first spring strings at the second position with an adjacent section of the second spring string to form a bed mesh.

In some embodiments of the present disclosure, the feeding mechanism includes a flipping assembly, the flipping assembly and the combination mechanism are located on the same side of the first loading mechanism, the flipping assembly includes a flipping frame and a magnetic assembly, the magnetic assembly is arranged on the flipping frame, the flipping assembly is configured to grab a side surface of each of the first spring strings in a magnetic manner and flip around an axis parallel to the first direction, so as to transfer the first spring strings to the second position.

In some embodiments of the present disclosure, the feeding mechanism includes a pushing assembly located on the other side of the first loading mechanism, and the pushing assembly is configured to push the first spring strings at the first position in a second direction perpendicular to the first direction.

In some embodiments of the present disclosure, the bed mesh combination device includes a cutting mechanism which is arranged on the first loading mechanism, and the cutting mechanism is configured to cut off the first spring strings after the first loading mechanism transports the first spring strings of the set length to the first position.

In some embodiments of the present disclosure, the cutting mechanism includes a pressing assembly and a cutter assembly; the pressing assembly includes two pressing parts which are configured to press each of the first spring strings to be cut at both sides of the respective first spring string, and the cutter assembly includes a cutter which is movable in a third direction parallel to a length direction of springs in the first spring strings, so as to cut off the cloth bag of the first spring strings.

In some embodiments of the present disclosure, the loading mechanism includes an upper conveyor belt and a lower conveyor belt; the first spring strings are transported between the upper conveyor belt and the lower conveyor belt, the upper conveyor belt is configured to abut against upper ends of springs in each of the first spring strings, and the lower conveyor belt is configured to abut against lower ends of the springs in the respective first spring string.

In some embodiments of the present disclosure, a discharging end of the second loading mechanism is provided with a rotatable toggling part rotatable around an axis parallel to a third direction, at least two toggling grooves are formed in an outer side surface of the toggling part at an interval circumferentially, and the toggling grooves are configured to pull the second spring string in the second direction when the toggling part rotates.

In some embodiments of the present disclosure, each of the first spring strings and the second spring string has a plurality of first combination positions and a plurality of second combination positions, one of each of the first combination positions and each of the second combination positions is an odd-numbered welding or sewing position, and the other one of each of the first combination positions and each of the second combination positions is an even-numbered welding or sewing position; under the action of the combination mechanism, the first combination positions of a M^{th} first spring string are welded or sewn with the first combination positions of an adjacent section of the second spring string, and the second combination positions of the (M+1)^{th} first spring string are welded or sewn with the second combination positions of an adjacent section of the second spring string, M being a positive integer, or under the action of the combination mechanism, the first combination positions of a N^{th} section of the second spring string are welded or sewn with the first combination positions of the adjacent first spring string, and the second combination positions of a (N+1)^{th} section of the second spring string are welded and sewn with the second combination positions of the adjacent first spring string, N being a positive integer.

In some embodiments of the present disclosure, the combination mechanism includes a plurality of first combiners and a plurality of second combiners; the first combiners are arranged as welding cutter assemblies and the second combiners are arranged as welding head assemblies, or the first combiners are arranged as sewing assemblies and the second combiners are arranged as cloth pressing assemblies; the first combiners are divided into two groups, the first combiners in each group are arranged at intervals in the first direction and a spacing between the first combiners is adjustable, and the two groups of first combiners are arranged in a staggered manner in the first direction, with one group of the first combiners being configured for welding or sewing the first combination positions of the first spring strings and the second spring string, and the other group of the first combiners being configured for welding or sewing the second combination positions of the first spring strings and the second spring string.

In some embodiments of the present disclosure, he plurality of second combiners are arranged at intervals in the first direction, and the second combiners is capable of reciprocating in the first direction, so as to switch the second combiners to pair with the two groups of first combiners respectively.

In some embodiments of the present disclosure, the plurality of second combiners are arranged at intervals in the first direction, and a quantity of the second combiners is equal to a sum of quantities of the two groups of first combiners; and the first combiners are movable up and down in the third direction, and is capable of reciprocating in the second direction to push the combined first spring strings and second spring string out of the second position.

In some embodiments of the present disclosure, the second combiners are movable up and down in a third direction or the second combiners is capable of being flipped around an axis parallel to the first direction for avoidance when the feeding mechanism arranges the first spring strings or the second loading mechanism arranges the second spring string.

The present disclosure provides a bed mesh combination method. The bed mesh combination device works by using the bed mesh combination method to combine the first spring strings and the second spring string into a bed mesh. The bed mesh combination method includes the following work flow:
moving the second loading mechanism in a first direction, so as to arrange the N^{th} section of the second spring string of the set length at the second position;
transporting, by the first loading mechanism, the M^{th} first spring string of the set length to the first position in the first direction, and transferring, by the feeding mechanism, the M^{th} first spring string from the first position to the second position;
moving the second loading mechanism reversely, so as to arrange the (N+1)^{th} section of the second spring string of the set length at the second position, where the M^{th} first spring string is located between the N^{th} section of the second spring string and the (N+1)^{th} section of the second spring;
welding or sewing, by the combination mechanism, the first combination positions of the N^{th} section of the second spring string and the first combination positions of the (N+1)^{th} section of the second spring string with the first combination positions of the M^{th} first spring;
transporting, by the first loading mechanism, the (M+1)^{th} first spring string of the set length to the first position in the first direction, and transferring, by the feeding mechanism, the (M+1)^{th} first spring string from the first position to the second position;
moving the second loading mechanism in the first direction, so as to arrange a (N+2)^{th} section of the second spring string of the set length at the second position, where the (M+1)^{th} first spring string is located between the (N+1)^{th} section of the second spring string and the (N+2)^{th} section of the second spring; and
welding or sewing, by the combination mechanism, the second combination positions of the (N+1)^{th} section of the second spring string and the second combination positions of the (N+2)^{th} section of the second spring string with the second combination positions of the (M+1)^{th} first spring string;
where the second loading mechanism performs at least one reciprocating motion in the first direction.

The present disclosure provides a bed mesh combination method. The bed mesh combination device works by using the bed mesh combination method to combine the first spring strings and the second spring string into a bed mesh. The bed mesh combination method includes the following work flow:
transporting, by the first loading mechanism, the M^{th} first spring string of the set length to the first position in the first direction, and transferring, by the feeding mechanism, the M^{th} first spring string from the first position to the second position;
moving the second loading mechanism in the first direction, so as to arrange the N^{th} section of the second spring string of the set length at the second position;
transporting, by the first loading mechanism, the (M+1)^{th} first spring string of the set length to the first position in the first direction, and transferring, by the feeding mechanism, the (M+1)^{th} first spring string from the first position to the second position, where the N^{th} section of the second spring string is located between the M^{th} first spring string and the (M+1)^{th} first spring string;
welding or sewing, by the combination mechanism, the first combination positions of the M^{th} first spring string and the first combination positions of the (M+1)^{th} first spring string with the first combination positions of the N^{th} section of the second spring string;
moving the second loading mechanism reversely, so as to arrange the (N+1)^{th} section of the second spring string of the set length at the second position;
transporting, by the first loading mechanism, a (M+2)^{th} first spring string of the set length to the first position in the first direction, and transferring, by the feeding mechanism, the (M+2)^{th} first spring string from the first position to the second position, where the (N+1)^{th} section of the second spring string is located between the (M+1)^{th} first spring string and the (M+2)^{th} first spring string; and
welding or sewing, by the combination mechanism, the second combination positions of the (M+1)^{th} first spring string and the second combination positions of the (M+2)^{th} first spring string with the second combination positions of the (N+1)^{th} section of the second spring string;
where the second loading mechanism performs at least one reciprocating motion in the first direction.

The bed mesh provided in the present disclosure is manufactured by the bed mesh combination method. The bed mesh includes the first spring strings and the second spring string, and the second spring string is distributed in an S shape or the second spring string distributed in the S shape are cut into sections with a length identical to the set length of the first spring strings.

In some embodiments of the present disclosure, a spacing between springs in each of the first spring strings is different from a spacing between springs in the second spring string.

In some embodiments of the present disclosure, spring strengths in the first spring strings and the second spring string are different.

The embodiments of the present disclosure at least have the following beneficial effects. In the bed mesh combination device, the first loading mechanism transfers the first spring strings of the set length to the first position, the feeding mechanism transfers the first spring strings from the first position to the second position, the second loading mechanism arranges the second spring string at the second position, and the combination mechanism welds or sews the first spring strings and the second spring string to form a bed mesh. In this case, compared with a conventional combination mode, in the bed mesh combination device provided by the embodiments of the present disclosure, the first spring strings are arranged at intervals in the second spring string laid back and forth. The first spring strings are welded or sewn with the adjacent sections of the second spring string. One first spring string and at least one section of the second spring string can be combined with the same number of welding or sewing, so that the efficiency is improved. The present disclosure can be widely applied to the technical field of bed mesh manufacturing.

### BRIEF DESCRIPTION OF DRAWINGS

The described and/or additional aspects and advantages of the embodiments of the present disclosure will become apparent and easily understood in conjunction with the following accompanying drawings. It should be noted that the embodiments shown in the following accompanying drawings are exemplary, and are only used to explain the present disclosure and cannot be understood as limiting the present disclosure.

FIG. 1A is a structural diagram of a bed mesh combination device.

FIG. 1B is a partial view of an area A in FIG. 1A.

FIG. 2A is a structural diagram of a flipping assembly.

FIG. 2B is a schematic structural diagram of the flipping assembly grabbing a spring string at a first position.

FIG. 2C is a schematic structural diagram of the flipping assembly transferring the spring string to a second position.

FIG. 3 is a structural diagram of a cutting mechanism.

FIG. 4A is a structural diagram of a combination mechanism in the bed mesh combination device, which shows that in the combination mechanism, a first combiner is a welding cutter assembly, and a second combiner is a welding head assembly.

FIG. 4B is a partial view of an area B in FIG. 4A.

FIG. 5A is a structural diagram of the combination mechanism in the bed mesh combination device, which shows that in the combination mechanism, a first combiner is a sewing assembly and a second combiner is a cloth pressing assembly.

FIG. 5B is a structural diagram of the sewing assembly and the cloth pressing assembly.

FIG. 6A is a schematic diagram of the first spring strings and the second spring string combining into a bed mesh.

FIG. 6B shows the combined bed mesh in FIG. 6A.

FIG. 6C is a schematic diagram of the first spring strings and the second spring string combining into the bed mesh.

FIG. 6D is a schematic diagram of the first spring strings and the second spring string combining into the bed mesh.

FIG. 6E is a schematic diagram of the first spring strings and the second spring string combining into the bed mesh.

Reference numerals: 1000. first loading mechanism; 1100. upper conveyor belt; 1200. lower conveyor belt; 2100. flipping assembly; 2101. flipping frame; 2102. magnetic part; 2103. magnetic partition; 2104. first guide rod; 2200. pushing assembly; 3100. first combiner; 3101. welding cutter assembly; 3102. sewing assembly; 3200. second combiner; 3201. welding head assembly; 3202. cloth pressing assembly; 3300. limiting assembly; 4000. cutting mechanism; 4101. pressing part; 4102. pressing driver; 4201. cutter; 4202. cutting driver; 5000. second loading mechanism; 5100. toggling part; 5101. toggling groove; 6100. first spring string; 6200. second spring string.

### DETAILED DESCRIPTION

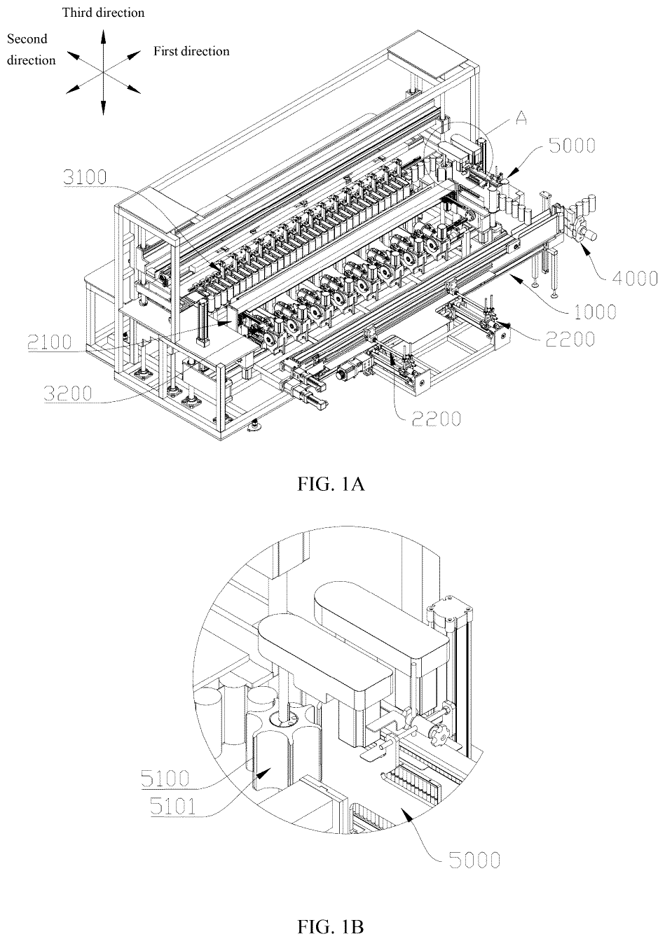

The embodiments of the present disclosure will be described in detail below in conjunction with FIG. 1A to FIG. 6E. Examples of the embodiments are shown in the accompanying drawings, where the same or similar reference numerals throughout represent the same or similar elements or elements with the same or similar functions. The embodiments described below with reference to the accompanying drawings are exemplary, and are only used to explain the present disclosure and cannot be understood as limiting the present disclosure.

In the description of the present disclosure, it should be understood that the orientation or positional relationships indicated by the terms “center”, “middle”, “longitudinal”, “transverse”, “length”, “width”, “thickness”, “upper”, “lower”, “front”, “rear”, “left”, “right”, “vertical”, “horizontal”, “top”, “bottom”, “inner”, “outer””, “axial”, “radial”, “circumferential”, and the like are based on the orientation or positional relationships shown in the accompanying drawings, and are only for the convenience of describing the present disclosure and simplifying the description rather than indicating or implying that the device or element referred to must have specific orientation and be constructed and operated in a specific orientation, and therefore should not be construed as limiting the present disclosure. Features defined with the terms such as “first” and “second” are used to distinguish feature names rather than having special meanings. In addition, features defined with the terms such as “first” and “second” may explicitly or implicitly include one or more of the features. In the description of the present disclosure, unless otherwise stated, “a plurality of” means two or more.

In the description of the present disclosure, it should be noted that, unless otherwise explicitly stated and limited, the terms such as “installation”, “connected” and “connection” should be understood in a broad sense. For example, it may be a fixed connection or a detachable connection, or an integrated connection; may be a mechanical connection or an electrical connection; may be a direct connection, or an indirect connection through an intermediate medium, or may be an internal connection between two components. For those of ordinary skill in the art, the specific meanings of the above terms in the present disclosure can be understood on a case-by-case basis.

The present disclosure relates to a mattress, which includes a bed mesh.

The present disclosure relates to a bed mesh, which is manufactured by a bed mesh combination device.

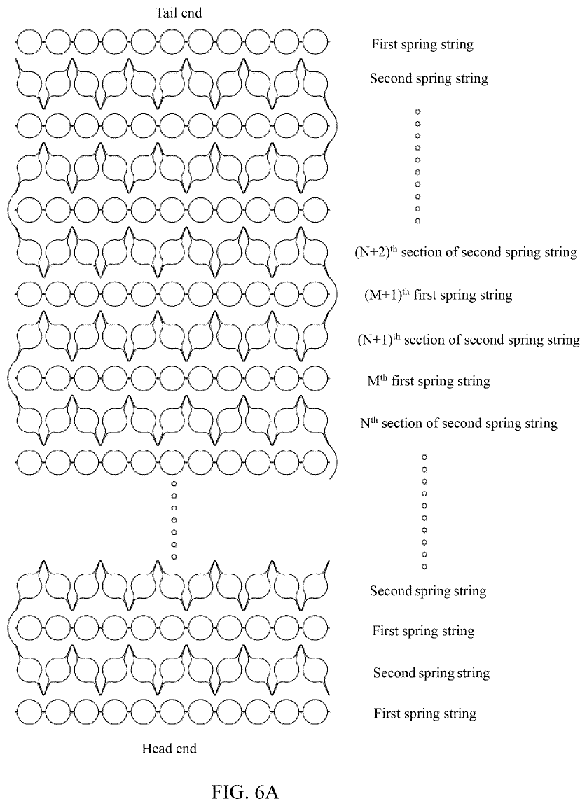

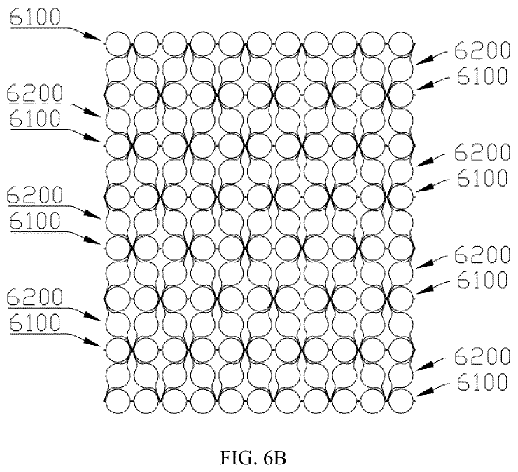

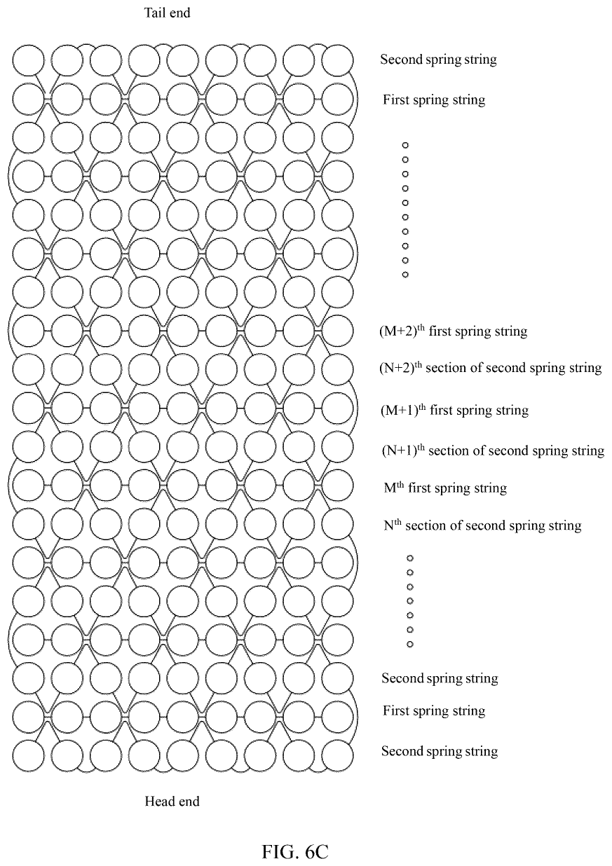

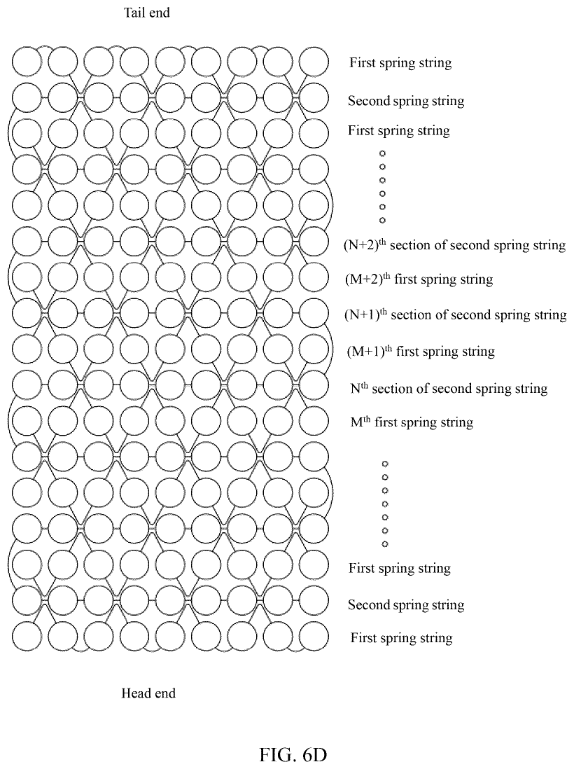

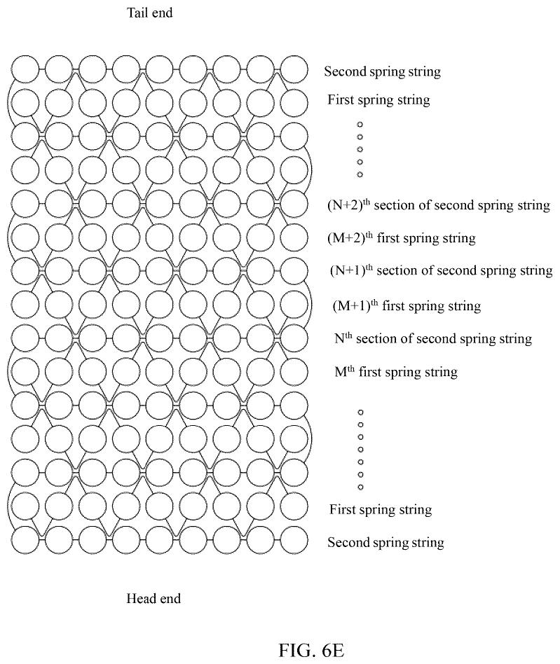

Specifically, combined with FIG. 6A to FIG. 6E, the bed mesh includes a plurality of first spring strings 6100 and a second spring string 6200. The bed mesh combination device welds or sews the first spring strings 6100 and the second spring string 6200 to form a bed mesh. The second spring string 6200 is a continuous spring string, and the bed mesh combination device distributes the second spring string 6200 in an S shape. The first spring strings 6100 and the second spring string 6200 are respectively arranged at intervals, and the first spring strings 6100 and the second spring string 6200 are arranged side by side and in parallel. The first spring strings 6100 are welded or sewn to the adjacent section of the second spring string 6200.

Regarding the second spring string 6200, as an alternative, the second spring string may be designed at least as follows: the bed mesh combination device cuts the continuous second spring string 6200 into sections with a set length. Specifically, the second spring string 6200 distributed in an S shape are cut into sections with the same length as the first spring strings 6100.

It should be noted that each of the first spring strings 6100 and the second spring string 6200 has a plurality of first combination positions and a plurality of second combination positions. The first combination positions and the second combination positions of the same spring string are spaced apart from each other. One of the first combination positions and the second combination positions is an odd-numbered welding or sewing position, and the other one thereof is an even-numbered welding or sewing position. Each of the first combination positions and the second combination positions is a fabric connection between two adjacent spring individuals in the spring string.

Combined with FIGS. 6A to 6E, the first spring strings 6100 and the second spring string 6200 are spaced apart from each other, and the first combination positions of the first spring string 6100 are welded or sewn with the first combination positions of the adjacent section of the second spring string 6200. The second combination positions of the first spring string 6100 are welded or sewn with the second combination positions of the adjacent section of the second spring string 6200.

As an implementation, combined with FIGS. 6A to 6C, in the bed mesh, the first combination positions of the M^{th} first spring string 6100 are welded or sewn with the first combination positions of the adjacent sections of the second spring string 6200, and the second combination positions of the (M+1)^{th} first spring string 6100 are welded or sewn with the second combination positions of the adjacent section of the second spring string 6200, M being a positive integer.

As another implementation, combined with FIGS. 6D and 6E, in the bed mesh, the first combination positions of the N^{th} section of the second spring string 6200 are welded or sewn with the first combination positions of the adjacent first spring strings 6100, and the second combination positions of the (N+1)^{th} section of the second spring string 6200 are welded or sewn with the second combination positions of the adjacent first spring strings 6100, N being a positive integer.

In some examples, at a head end of the bed mesh, the first one of the spring strings is the first spring string 6100. In other examples, at the head end of the bed mesh, the first one of the spring strings is the second spring string 6200.

In some examples, at a tail end of the bed mesh, the last one of the spring strings is the first spring string 6100. In other examples, at the tail end of the bed mesh, the last one of the spring strings is the second spring string 6200.

As an implementation, the spacing between the springs in the first spring strings 6100 is different from that in the second spring string 6200. Different spacings between the springs results in different strengths of the spring strings formed. Combining two types of spring strings of different strengths into a bed mesh can enhance the structural stability of the bed mesh.

Further, the spacing between the springs in the first spring strings 6100 is less than that in the second spring string 6200, and the first spring strings 6100 shape the bed mesh.

Certainly, as an alternative, it may be designed at least as follows: in some alternative examples, the spacing between the springs in the first spring strings 6100 is greater than that in the second spring string 6200. In some other alternative examples, the spacing between the springs in the first spring strings 6100 is equal to that in the second spring string 6200. In this case, although there is no difference in strength between the first spring strings 6100 and the second spring string 6200, since the second spring string 6200 is arranged in an S shape and the first spring strings 6100 has a set length, the efficiency of making the bed mesh can be improved, and combining two different forms of spring strings into the bed mesh can also improve the structural stability.

As an implementation, the springs in the first spring strings 6100 and the second spring string 6200 have different spring strengths. Different spring specifications have different strengths. In this case, the first spring strings 6100 and the second spring string 6200 made separately have different strengths, thereby enhancing the structural stability of the bed mesh.

Specifically, the springs with different strengths are made of steel wires of different strengths or different thicknesses, and then the first spring strings 6100 and the second spring string 6200 are respectively made.

In order to achieve different strengths for the first spring strings 6100 and the second spring string 6200, there are at least the following alternative examples.

In some alternative examples, the spring waist diameters in the first spring strings 6100 and the second spring string 6200 are different.

In some other alternative examples, the numbers of spring coils in the first spring strings 6100 and the second spring string 6200 are different.

Other structures and operations of the bed mesh have been documented in the related art for those of ordinary skill in the art, and will not be described in detail herein. The structure of the bed mesh combination device will be introduced below.

The present disclosure relates to bed mesh combination device. The bed mesh combination device includes a first loading mechanism 1000, a feeding mechanism, a second loading mechanism 5000, and a combination mechanism. The first loading mechanism 1000 is used to transport first spring strings. The first loading mechanism 1000 transports the first spring strings of a set length to a first position in the bed mesh combination device. The feeding mechanism transfers the first spring strings from the first position to a second position in the bed mesh combination device. The second loading mechanism 5000 is used to transport the second spring string, and arrange the second spring string at the second position into sections with the set length. The combination mechanism welds or sews the first spring strings and the second spring string at the second position.

Specifically, the first loading mechanism 1000 transports the first spring strings to the first position in a first direction parallel to a length direction of a cloth bag, and the first spring strings are distributed parallel to the first direction at the first position. Moreover, after the first spring strings are transferred to the second position, the first spring strings are parallel to the first direction at the second position.

The second loading mechanism 5000 can reciprocate in the first direction in the bed mesh combination device, so as to continuously arrange the second spring string back and forth in the first direction at the second position. Furthermore, at the second position, the second loading mechanism 5000 arranges the second spring string into an S shape in a reciprocating manner. At the second position, the second spring string is parallel to the first direction. It can be understood that every time the second loading mechanism 5000 moves, the feeding mechanism will correspondingly transfer one first spring string to the second position. In this case, there is one first spring string between two adjacent sections of the second spring string, and the second spring string is parallel to the first spring strings. Further, the combination mechanism welds or sews the first spring strings at the second position with the adjacent sections of the second spring string to form a bed mesh.

As an implementation, the feeding mechanism transfers the first spring strings from the first position to the second position in a flipping manner. Combined with FIG. 1A, the feeding mechanism includes a flipping assembly 2100. The flipping assembly 2100 and the combination mechanism are located on the same side of the first loading mechanism 1000. The flipping assembly 2100 grabs the first spring strings at the first position and transfers the first spring strings to the second position in a flipping manner.

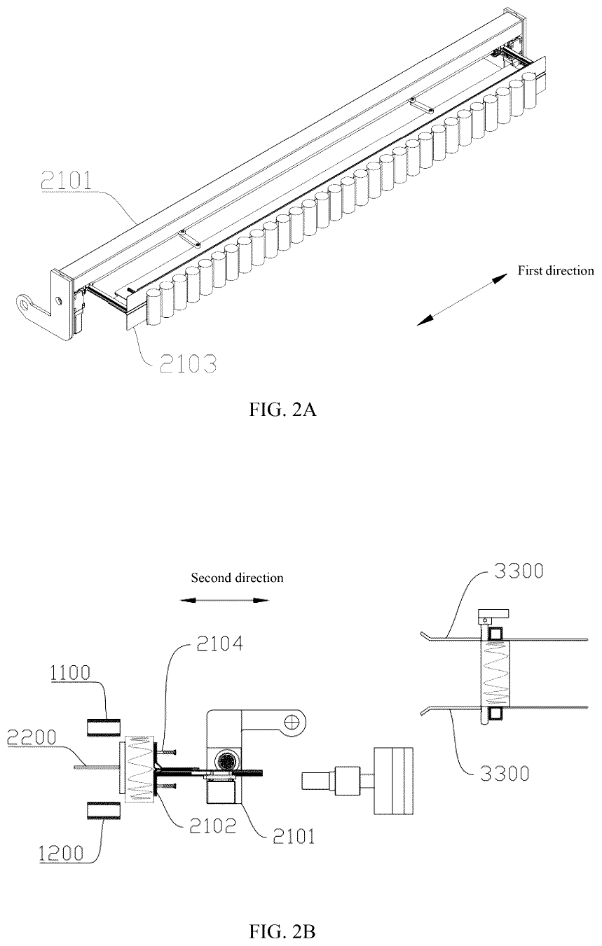

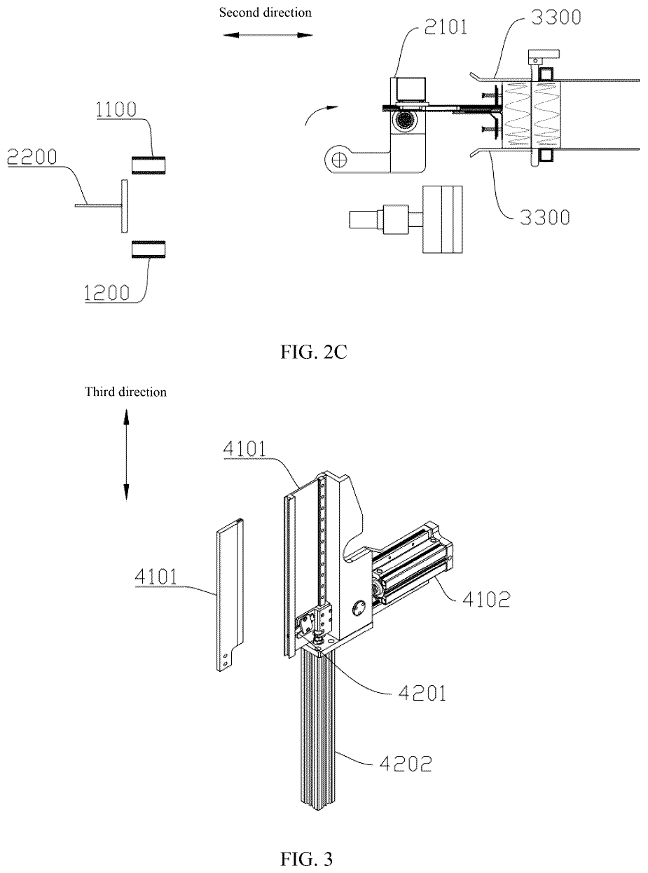

Specifically, the flipping assembly 2100 grabs the side surfaces of the first spring strings in a magnetic manner. Combined with FIG. 2A, the flipping assembly 2100 includes a flipping frame 2101 and a magnetic assembly. The magnetic assembly is arranged on the flipping frame 2101. After the magnetic assembly grabs the side surfaces of the first spring strings, the flipping frame 2101 flips around an axis parallel to the first direction, so as to transfer the first spring strings to the second position, and the magnetic assembly releases the first spring strings.

Further, the flipping assembly 2100 includes a grabbing driver. The grabbing driver is arranged on the flipping frame 2101. The magnetic assembly is connected to the grabbing driver. Driven by the grabbing driver, the magnetic assembly moves close to or away from the first spring strings to be grabbed. Specifically, the grabbing driver drives the magnetic assembly in the form of a motor, a cylinder, a hydraulic cylinder, or a ball screw pair.

In some examples, combined with FIGS. 2A to 2C, the magnetic assembly includes a magnetic part 2102 and a magnetic partition 2103. The magnetic partition 2103 extends parallel to the first direction, and one side of the magnetic partition 2103 is attached to the side surfaces of the first spring strings. The magnetic part 2102 can move close to or away from the other side of the magnetic partition 2103, so that the magnetic part can attract or release the first spring strings. The magnetic part 2102 is set to be a permanent magnet. It can be understood that when the magnetic part 2102 is close to the magnetic partition 2103, the first spring strings are magnetically fixed to a side surface of the magnetic partition 2103. When the magnetic part 2102 is away from the magnetic partition 2103, the first spring strings and the magnetic partition 2103 can be separated.

The magnetic partition 2103 is arranged on the flipping frame 2101. Alternatively, in a case that the flipping assembly 2100 is provided with a grabbing driver, the magnetic partition 2103 is connected to the grabbing driver. Combined with FIG. 2B, a first guide rod 2104 is arranged on the side surface of the magnetic partition 2103. The first guide rod 2104 extends through the magnetic part 2102, and serves to guide the movement of the magnetic part 2102 close to or away from the magnetic partition 2103. The flipping frame 2101 is provided with a first driving assembly, which is connected to the magnetic part 2102 and drives the magnetic part 2102 to be close to or away from the magnetic partition 2103. The first driving assembly is configured as a gear and rack structure. A gear is arranged on the flipping frame 2101. A rack is connected to the magnetic part 2102. When the motor drives the gear to rotate, the rack can drive the magnetic part 2102 to move. A spring is arranged around the first guide rod 2104, and the spring abuts against the magnetic part 2102 to assist the magnetic part 2102 to be close to the magnetic partition 2103 and ensure that the magnetic part 2102 is attached to the magnetic partition 2103, thereby ensuring magnetic attraction of the magnetic assembly to the first spring strings.

It can be understood that the first driving assembly may alternatively be configured as a linear motor, a ball screw pair, or a hydraulic mechanism.

In some alternative examples, the magnetic assembly includes an electromagnetic device attached to the side surfaces of the first spring strings. When powered on, the electromagnetic device has a magnetic attraction force. When the electromagnetic device is powered off, the magnetic attraction force disappears, so that the first spring strings can be grabbed or released.

In some embodiments, combined with FIG. 1A, the feeding mechanism includes a pushing assembly 2200, which is arranged on the frame of the bed mesh combination device. The pushing assembly 2200 is located on the other side of the first loading mechanism 1000, and pushes the first spring strings at the first position in a second direction perpendicular to the first direction. Combined with FIG. 1A, the pushing assembly 2200 and the flipping assembly 2100 are respectively located on opposite sides of the first loading mechanism 1000. In this case, the pushing assembly 2200 pushes the first spring strings toward the flipping assembly 2100, so that the first spring strings are attached to the side surface of the magnetic partition 2103. Specifically, the pushing assembly 2200 is configured as a linear module or a pneumatic cylinder or a hydraulic cylinder. An output end of the pushing assembly 2200 is provided with a pushing block, which is used to abut against the side surfaces of the first spring strings.

It can be understood that there are at least two pushing assemblies 2200. The pushing assemblies 2200 are spaced apart in the first direction, and push the springs simultaneously. Further, the feeding mechanism includes a push plate extending in the first direction. The push plate and the push assemblies 2200 are located on the same side of the first loading mechanism 1000. The push plate is connected to the output end of each push assembly 2200, the push assemblies 2200 push the push plate simultaneously, and the push plate abuts against the side surfaces of the first spring strings.

As another alternative implementation, the feeding mechanism pushes the first spring strings from the first position to the second position in a pushing manner. In this case, the feeding mechanism has the pushing assembly 2200 rather than the flipping assembly 2100.

Further, the pushing block or the push plate at the output end of each push assembly 2200 is designed to fix the first spring strings by means of magnetic attraction, so as to prevent the first spring strings from tipping or deflecting when pushed from the first position to the second position.

As an implementation, combined with FIGS. 2B and 2C, the first loading mechanism 1000 includes an upper conveyor belt 1100 and a lower conveyor belt 1200. The upper conveyor belt 1100 and the lower conveyor belt 1200 are arranged both parallel to the first direction, and the first spring strings are transported between the upper conveyor belt 1100 and the lower conveyor belt 1200. It can be understood that the upper conveyor belt 1100 is used to abut against the upper ends of the springs in the first spring strings, and the lower conveyor belt 1200 is used to abut against the lower ends of the springs in the first spring strings, thereby ensuring that the first spring strings are transported in the first loading position 1000 with the springs kept vertical.

Further, at least one of the upper conveyor belt 1100 and the lower conveyor belt 1200 is configured with a motor to obtain power.

As an implementation, the first spring strings entering the first loading mechanism 1000 in the bed mesh combination device are in the shape of a continuous strip. Combined with FIG. 1A, the bed mesh combination device includes a cutting mechanism 4000, which is arranged in the first loading mechanism 1000. The first loading mechanism 1000 transports the first spring string of a set length to the first position and then the cutting mechanism 4000 cuts off the first spring string.

It can be understood that the cutting mechanism 4000 is arranged upstream or at an entrance of the first loading mechanism 1000, and the starting frequency of the cutting mechanism 4000 is set according to a conveying speed of the first loading mechanism 1000, or a sensor is used to measure the length of the first spring strings conveyed in the first loading mechanism 1000, so that the cutting mechanism 4000 cuts off the first spring strings according to the set length. Specifically, the cutting mechanism 4000 includes a pressing assembly and a cutter assembly. The pressing assembly presses positions on both sides of the first spring string to be cut, so that the cutter assembly cuts a cloth bag of the first spring strings.

Combined with FIG. 3, the pressing assembly includes two pressing parts 4101 extending in a third direction parallel to the length direction of the springs in the first spring strings. The two pressing parts 4101 are respectively located on opposite sides of the first loading mechanism 1000, can move close to or away from each other, and are used to press respectively the positions on both sides of the first spring strings to be cut.

Combined with FIG. 3, the pressing assembly includes a pressing driver 4102, and at least one of the two pressing parts 4101 is configured with the pressing driver 4102. In some examples, one of the pressing parts 4101 is connected to the pressing driver 4102, and the other pressing part 4101 is fixedly arranged on the frame of the bed mesh combination device. Driven by the pressing driver 4102, one of the pressing parts 4101 moves close to or away from the other pressing part 4101, so that the two pressing parts 4101 press the first spring strings at both sides of the first spring strings. In some alternative examples, the two pressing parts 4101 are respectively configured with the pressing driver 4102.

It can be understood that, combined with FIG. 3, the cutter assembly includes a cutter 4201, which can move in the third direction, so as to cut off the cloth bag of the first spring strings. Specifically, the cutter assembly includes a cutting driver 4202. The cutter 4201 is connected to the cutting driver 4202. Driven by the cutting driver 4202, the cutter 4201 completes cutting of the cloth bag of the first spring strings. Combined with FIG. 3, the cutter 4201 is movably arranged on the side surface of one of the pressing parts 4101, and the cutting driver 4202 is arranged on the pressing part 4101 where the cutter 4201 is located. Further, the pressing part 4101 where the cutter 4201 is located is the pressing part 4101 configured with the pressing driver 4102.

Certainly, transmission and cutting of the first spring strings can also be designed as follows: the first spring strings are pre-cut to a set length and fed to the first loading mechanism 1000 one by one. In this case, it is not necessary to use the cutting mechanism 4000 to cut off the first spring strings in the first loading mechanism 1000.

As an implementation, the discharging end of the second feeding mechanism 5000 is provided with a rotatable toggling part 5100, which rotates in an axis parallel to the third direction. When the second feeding mechanism 5000 moves in the second direction, the toggling part 5100 arranges the second spring string in the second position in the second direction.

Combined with FIG. 1B, at least two toggling grooves 5101 are formed at an interval in the outer side surface of the toggling part 5100 circumferentially. The toggling grooves 5101 are formed in the third direction. When the toggling part 5100 rotates, the toggling grooves 5101 pull the second spring string in the second direction. Specifically, during a loading process of the second loading mechanism 5000, the outer sides of the front springs in the second spring string are partially engaged in the toggle grooves 5101. As the second loading mechanism 5000 moves and the toggling part 5100 rotate, the toggling part 5100 toggles the springs through the toggling grooves 5101, thereby pulling the second spring string.

Further, the toggling parts 5100 are respectively arranged on both sides of the discharging end of the second loading mechanism 5000, so that the second loading mechanism 5000 can arrange the second spring string in the second position during the reciprocating motion.

As another alternative implementation, the second loading mechanism 5000 includes two second loading conveyor belts, which are arranged oppositely. The second spring string is transported between the two second loading conveyor belts in the second direction, and at least one second loading conveyor belt is connected to a motor with power, so as to transport the second spring string.

It can be understood that in a case that the second loading mechanism 5000 is provided with the second loading conveyor belts, the toggling parts 5100 can also be arranged at the discharging end of the second loading mechanism 5000.

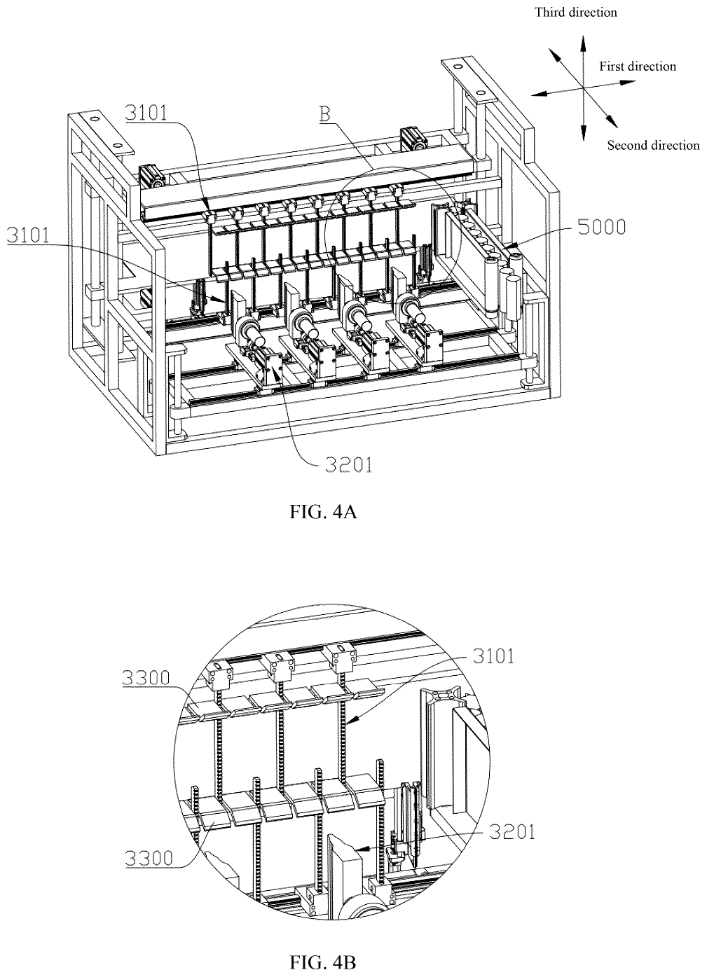

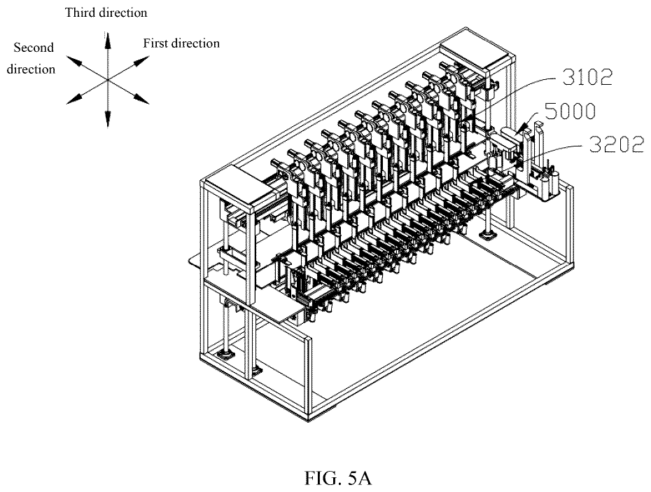

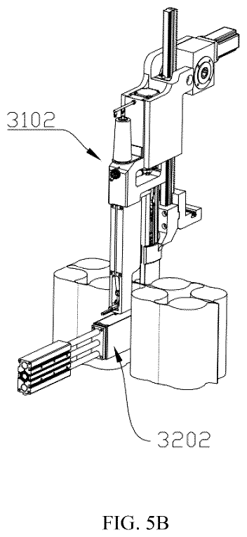

As an implementation, combined with FIGS. 4A to 5A, the combination mechanism includes a plurality of first combiners 3100 and a plurality of second combiners 3200. The first combiners 3100 and the second combiners 3200 are used to weld or sew the combination positions of the first spring strings and the second spring string. Specifically, combined with FIGS. 4A and 4B, the first combiners 3100 are configured as welding cutter assemblies 3101, and the second combiners 3200 are configured as welding head assemblies 3201. Alternatively, with reference to FIGS. 5A and 5B, the first combiners 3100 are configured as sewing assemblies 3102, and the second combiners 3200 are configured as cloth pressing assemblies 3202.

When the first spring strings and the second spring string are welded or sewn, the paired first combiners 3100 and the second combiners 3200 move close to each other. After the welding or sewing is completed, the paired first combiners 3100 and the second combiners 3200 move away from each other. It can be understood that at the second position, the first combiners 3100 and the second combiners 3200 are respectively located on both sides of the first spring strings and the second spring string to be combined. Moreover, the second combiners 3200 are located at the second position close to an incoming side of the first spring strings, and the first combiners 3100 are located at the second position close to a discharging end of the first and second spring strings.

The first combiners 3100 are divided into two groups, and the first combiners 3100 in each group are spaced apart in the first direction, to correspond to the first combination positions and the second combination positions. The positions of the two groups of first combiners 3100 are staggered in the first direction, with the first combiners 3100 of one group being located at intervals between the adjacent first combiners 3100 of the other group. In this case, one group of first combiners 3100 is used to weld or sew the first combination positions of the first spring strings and the second spring string, and the other group of first combiners 3100 is used to weld or sew the second combination positions of the first spring strings and the second spring string.

In some examples, the first combiners 3100 can move up and down in the third direction, so that the first combiners 3100 can enter and exit the first spring strings or the second spring string. Specifically, one group of the first combiners 3100 enters the spring strings from top to bottom, and the other group of the first combiners 3100 enter the spring strings from bottom to top. It can be understood that one group of the first combiners 3100 is inserted into the first combination positions from top to bottom. After welding or sewing by the first combiners 3100 and the second combiners 3200, the first combiners 3100 exit the second position from bottom to top, the next first spring string or the next section of the second spring string is arranged at the second position, and the other group of the first combiners 3100 is inserted into the second combination positions from bottom to top. After the first combiners 3100 and the second combiners 3200 complete the welding or sewing, the first combiners 3100 exit the second position from top to bottom.

Further, the first combiners 3100 can reciprocate in the second direction to push the combined first spring strings and the second spring string out of the second position. After completing welding or sewing, the first combiners 3100 push the combined first spring strings and the second spring string out from the second position by a set displacement in the second direction, so that a position is vacated at the second position for arranging the next first spring string or the next section of the second spring string. Specifically, after welding or sewing the first combination positions, the corresponding first combiners 3100 first push the first spring strings and the second spring string a set distance in the second direction, and then exit the spring strings from bottom to top; after welding or sewing the second combination positions, the corresponding first combiners 3100 first push the first spring strings and the second spring string a set distance in the second direction, and then exit the spring strings from top to bottom.

In some other alternative examples, the first combiners 3100 can move up and down in the third direction and push the first spring strings and the second spring string out of the second position through conveyor belts or push plates. It can be understood that in this case, the combination mechanism does not use the first combiners 3100 to push the first spring strings and the second spring string in the second direction.

As an implementation, the spacing between the first combiners 3100 is adjustable. Specifically, the spacing between the first combiners 3100 in each group is adjustable, so that the combination mechanism can adapt to the first spring strings and the third spring strings with different waist diameters.

As an implementation, the plurality of second combiners 3200 are arranged at intervals in the first direction, and the second combiners 3200 can reciprocate in the first direction, so as to switch the second combiners 3200 to pair with the two groups of first combiners 3100 respectively. The number of second combiners 3200 is equal to that of the first combiners 3100 in each group. It can be understood that when the first combination positions are welded or sewn, the second combiners 3200 move in the second direction to positions where they pair with one group of the first combiners 3100, and when the second combination positions are welded or sewn, the second combiners 3200 move in the first direction to positions where they pair with another group of the first combiners 3100.

Further, the second combiners 3200 can move close to or away from the first combiners 3100, so that the second combiners 3200 and the first combiners 3100 can be attached to both sides of the first combination positions or the second combination positions, respectively. Specifically, the combination mechanism includes a second driving assembly. The second combiners 3200 are connected to the second driving assembly, and the second driving assembly drives the second combiners 3200 to move in the second direction, so as to make the second combiners 3200 move close to or away from the first combiners 3100. In some examples, the second driving assembly drives the second combiners 3200 in the form of a motor, a pneumatic cylinder, a hydraulic cylinder or a ball screw pair.

As another alternative implementation, the plurality of second combiners 3200 are arranged at intervals in the first direction, and the number of the second combiners 3200 is equal to the sum of the numbers of the two groups of first combiners 3100. In this case, when the first combination positions are welded or sewn, each of the second combiners 3200 paired with one group of the first combiners 3100 approaches the corresponding first combiner 3100 synchronously; when the second combination positions are welded or sewn, each of the second combiners 3200 paired with the other group of the first combiners 3100 approaches the corresponding first combiner 3100 synchronously.

As an implementation, the second combiners 3200 can move to an avoidance position in the third direction, so as to avoid the first spring strings transferred from the first position to the second position and to avoid the second spring string arranged by the second loading mechanism 5000. Specifically, the second combiners 3200 can move from top to bottom to the avoidance position. After the first spring string or the second spring string is arranged at the second position, the second combiners 3200 move from bottom to top to reset. Further, the second combiners 3200 move to the avoidance position in the form of a motor, a cylinder, a hydraulic cylinder, or a ball screw pair.

As another alternative implementation, the second combiners 3200 avoid, in a rotating manner, the first spring strings transferred from the first position to the second position and the second spring string arranged by the second loading mechanism 5000. Specifically, the second combiners 3200 can rotate around an axis parallel to the first direction or the second direction to the avoidance position.

As an implementation, combined with FIG. 4B, the combination mechanism includes two limiting assemblies 3300, which extend in the first direction. The first spring strings and the second spring string at the second position are located between the two limiting assemblies 3300, and the two limiting assemblies 3300 respectively abut against the upper ends and the lower ends of the springs. Combined with FIG. 4B, each of the limiting assemblies 3300 includes at least two limiting plates spaced apart in the first direction, and a spacing area between two adjacent limiting plates is used to avoid the first combiners 3100.

Further, at least one limiting assembly 3300 can move up and down in the third direction to adjust the spacing between the two limiting assemblies 3300, so as to adapt to springs of different heights. In some examples, both of the two limiting assemblies 3300 can move in the third direction. It can be understood that the two limiting assemblies 3300 are respectively configured with limiting driving assemblies, which drive the limiting assemblies 3300 to move up and down in the form of a motor, a pneumatic cylinder, a hydraulic cylinder, or a ball screw pair. In some other alternative examples, one of the limiting assemblies 3300 is configured with the limiting driving assembly, and the other limiting assembly 3300 keeps its position fixed.

As an implementation, the combination mechanism combines the first spring strings and the second spring string in a welding manner. Specifically, combined with FIGS. 4A and 4B, the first combiners 3100 are configured as welding cutter assemblies 3101 and the second combiners 3200 are configured as welding head assemblies 3201. Welding cutters of the welding cutter assemblies 3101 extend in the third direction, and welding heads of the welding head assemblies 3201 can move close to or away from the welding cutters. Further, each welding head assembly 3201 includes an ultrasonic welding head and a welding head driver, and the welding head driver drives the ultrasonic welding head to move close to or away from the welding cutter.

As another alternative implementation, the combination mechanism combines the first spring strings and the second spring string in a sewing manner. Specifically, combined with FIGS. 5A and 5B, the first combiners 3100 are configured as sewing assemblies 3102 and the second combiners 3200 are configured as cloth pressing assemblies 3202. It can be understood that the cloth pressing assemblies 3202 and the sewing assemblies 3102 compress the sewing positions of the first spring strings and the second spring string, and the sewing assemblies 3102 sew and combine the first spring strings and the second spring string.

Specifically, each cloth pressing assembly 3202 includes a cloth pressing part, and each sewing assembly 3102 includes a sewing head, a sewing driver, and a cloth clamping part. The cloth clamping parts and the cloth pressing parts cooperate to clamp the sewing positions of the first spring strings and the second spring string. The sewing heads are connected to the sewing drivers. Driven by the sewing drivers, the sewing heads complete sewing.

The present disclosure will be described in detail below with reference to specific embodiments. It should be noted that the following description is only illustrative, rather than a specific limitation of the present disclosure.

The present disclosure relates to a bed mesh combination method. The bed mesh combination device works by using the bed mesh combination method to combine the first spring strings and the second spring string into a bed mesh.

Combined with FIGS. 6A and 6C, the bed mesh assembly method includes the following workflow.

The second loading mechanism 5000 moves in the first direction, so as to arrange the N^{th} section of the second spring string of a set length at the second position.

The first loading mechanism 1000 transports the M^{th} first spring string of the set length to the first position in the first direction, and the feeding mechanism transfers the M^{th} first spring string from the first position to the second position.

The second loading mechanism 5000 moves reversely, so as to arrange the (N+1)^{th} section of the second spring string of the set length at the second position, the M^{th} first spring string being located between the N^{th} section of the second spring string and the (N+1)^{th} section of the second spring string.

The combination mechanism welds or sews both the first combination positions of the N^{th} section of the second spring string and the first combination positions of the (N+1)^{th} section of the second spring string with the first combination positions of the M^{th} first spring string.

The first loading mechanism 1000 transports the (M+1)^{th} first spring string of the set length to the first position in the first direction, and the feeding mechanism transfers the (M+1)^{th} first spring string from the first position to the second position.

The second loading mechanism moves in the first direction, so as to arrange the (N+2)^{th} section of the second spring string of the set length at the second position, the (M+1)^{th} first spring string being located between the (N+1)^{th} section of the second spring string and the (N+2)^{th} section of the second spring string.

The combination mechanism welds or sews the second combination positions of the (N+1)^{th} section of the second spring string and the second combination positions of the (N+2)^{th} section of the second spring string with the second combination positions of the (M+1)^{th} first spring string.

It can be understood that the second loading mechanism 5000 performs at least one reciprocating motion in the first direction, so that the second spring string can be arranged in an S shape. Reasoning by analogy according to the above process, M is a positive integer, N is a positive integer, the (M+2)^{th} first spring string and the adjacent sections of the second spring string are all connected through the first combination positions, and the (M+3)^{th} first spring string and the adjacent sections of the second spring string are all connected through the second combination positions. Therefore, the combination mechanism welds the plurality of first spring strings with the S-shaped second spring string or the combination mechanism sews the plurality of first spring strings into the S-shaped second spring string to form a bed mesh.

It should be noted that when the combination mechanism welds or sews the first spring strings and the second spring string, the corresponding first combiners 3100 and the second combiners 3200 move close to each other, and three first combination positions or second combination positions corresponding to the first spring string and the second spring string on both sides are welded or sewn simultaneously.

Further, when the bed mesh combination device makes a bed mesh, the first spring string of the bed mesh may be a second spring string. Specifically, a first section of the second spring string is first arranged at the second position, and then the first one of the first spring strings is arranged. Alternatively, the first spring string of the bed mesh may also be a first spring string. Specifically, the first one of the first spring strings is arranged at the second position first, and then a first section of the second spring string is arranged.

As an implementation, combined with FIG. 6A, the bed mesh combination device arranges the first one of the spring strings of the bed mesh as the first spring string. In this case, when the positions where the second one of the first spring strings are welded or sewn with the adjacent sections of second spring string are one of the first combination positions and the second combination positions, the positions where the first one of the first spring strings is welded or sewn with the adjacent section of the second spring string are the other one of the first combination positions and the second combination positions.

It can be understood that after the first loading mechanism 1000, the feeding mechanism, the second loading mechanism 5000, and the combination mechanism coordinately complete the set number of actions, the initial spring string of the bed mesh made will be the first spring string, and then the same first spring string is welded or sewn with the first combination positions of the second spring string on both sides at the same time, or the same first spring string is welded or sewn with the second combination positions of the second spring string on both sides at the same time. Moreover, in the two adjacent first spring strings, one of the first spring strings is welded or sewn at the first combination positions, and the other first spring string is welded or sewn at the second combination positions.

As another alternative implementation, combined with FIG. 6C, the bed mesh combination device arranges the first one of the spring strings of the bed mesh as the second spring string.

As an implementation, combined with FIG. 6A, the bed mesh combination device arranges the last one of the spring strings of the bed mesh as the first spring string. Specifically, the second loading mechanism 5000 arranges the last section of the second spring string of the bed mesh at the second position, and then the feeding mechanism transfers the last first spring string of the bed mesh to the second position.

It should be noted that when the positions where the penultimate first spring string is welded or sewn with the adjacent section of the second spring string are one of the first combination positions and the second combination positions, the positions where the last first spring string is welded or sewn with the adjacent section of the second spring string are the other one of the first combination positions and the second combination positions.

As another alternative implementation, combined with FIG. 6C, the bed mesh combination device arranges the last spring string of the bed mesh as the second spring string.

As an implementation, after the first loading mechanism 1000 transports the first spring strings of the set length in the first direction to the first position, the cutting mechanism 4000 cuts off the first spring strings.

As an implementation, at the first position, the pushing assembly 2200 pushes the first spring strings to the magnetic assembly of the flipping assembly 2100 in the second direction, and the flipping assembly 2100 transfers the first spring strings from the first position to the second position in a flipping manner.

As another alternative implementation, the pushing assembly 2200 pushes the first spring strings from the first position to the second position in the second direction.

As an implementation, the first combiners 3100 can move in the second direction to push the combined first spring strings and second spring string out of the second position by a set displacement, so as to leave space at the second position to arrange the next first spring string or the next section of the second spring string.

The present disclosure relates to a bed mesh combination method. The bed mesh combination device works by using the bed mesh combination method to combine the first spring strings and the second spring string into a bed mesh.

Combined with FIGS. 6D and 6E, the bed mesh assembly method includes the following workflow.

The first loading mechanism 1000 transports the M^{th} first spring string of a set length to the first position in the first direction, and the feeding mechanism transfers the M^{th} first spring string from the first position to the second position.

The second loading mechanism 5000 moves in the first direction, so as to arrange the N^{th} section of the second spring string of the set length at the second position.

The first loading mechanism 1000 transports the (M+1)^{th} first spring string of the set length to the first position in the first direction, and the feeding mechanism transfers the (M+1)^{th} first spring string from the first position to the second position, the N^{th} section of the second spring string being located between the M^{th} first spring string and the (M+1)^{th} first spring string.

The combination mechanism welds or sews both the first combination positions of the M^{th} first spring string and the first combination positions of the (M+1)^{th} first spring with the first combination positions of the N^{th} section of the second spring string.

The second loading mechanism 5000 moves reversely, so as to arrange the (N+1)^{th} section of the second spring string of the set length at the second position.

The first loading mechanism 1000 transports the (M+2)^{th} first spring string of the set length to the first position in the first direction, and the feeding mechanism transfers the (M+2)^{th} first spring string from the first position to the second position, the (N+1)^{th} section of the second spring string being located between the (M+1)^{th} first spring string and the (M+2)^{th} first spring string.

The combination mechanism welds the second combination positions of the (M+1)^{th} first spring string and the second combination positions of the (M+2)^{th} first spring string with the second combination positions of the (N+1)^{th} section of the second spring string.

It can be understood that if the second loading mechanism 5000 performs at least one reciprocating motion in the first direction, the second spring string can be arranged in an S shape. Reasoning by analogy according to the above process, M is a positive integer, N is a positive integer, the (N+2)^{th} section of the second spring string and the adjacent first spring strings are all connected through the first combination positions, and the (N+3)^{th} section of the second spring string 200 and the adjacent first spring strings are all connected through the second combination positions, so that the combination mechanism welds the plurality of first spring strings with the S-shaped second spring string or the combination mechanism sews the plurality of first spring strings to the S-shaped second spring string to form a bed mesh.

It should be noted that when the combination mechanism welds or sews the first spring strings and the second spring string, the corresponding first combiners 3100 and the second combiners 3200 move close to each other, and three first combination positions or second combination positions corresponding to the second spring string and the first spring strings on both sides are welded or sewn simultaneously.

Further, when the bed mesh combination device makes a bed mesh, the first one of the spring strings of the bed mesh may be the second spring string. Specifically, a first section of the second spring string is first arranged at the second position, and then the first one of the first spring strings is arranged. Alternatively, the first one of the spring strings of the bed mesh may also be the first spring string. Specifically, the first one of the first spring strings is first arranged at the second position, and then a first section of the second spring string is arranged.

As an implementation, combined with FIG. 6D, the first one of the spring strings of the bed mesh is the first spring string.

It can be understood that after the first loading mechanism 1000, the feeding mechanism, and the combination mechanism coordinately complete the set number of actions, the initial spring string of the bed mesh is the first spring string, and the same section of the second spring string is welded or sewn with both the first combination positions of the second spring string on both sides, or the same section of the second spring string is welded or sewn with both the second combination positions of the second spring string on both sides. Moreover, in the two adjacent sections of the second spring string, one section of the second spring string is welded or sewn at the first combination positions, and the other section of the second spring string is welded or sewn at the second combination positions.

As another alternative implementation, combined with FIG. 6E, the first one of the spring strings of the bed mesh is the first section of the second spring string. In this case, when the positions where the second section of the second spring string are welded or sewn with the adjacent first spring strings is one of the first combination positions and the second combination positions, and the positions where the first section of the second spring string are welded or sewn with the adjacent first spring string are the other one of the first combination positions and the second combination positions.

As an implementation, combined with FIG. 6D, the bed mesh combination device arranges the last spring string of the bed mesh as the first spring string.

As another alternative implementation, combined with FIG. 6E, the bed mesh combination device arranges the last spring string of the bed mesh as the second spring string. Specifically, the feeding mechanism transfers the last first spring string of the bed mesh to the second position, and then the second loading structure arranges the last section of the second spring string of the bed mesh at the second position.

It should be noted that when the positions where the penultimate section of the second spring string are welded or sewn with the adjacent first spring strings are one of the first combination positions and the second combination positions, the positions where the last section of the second spring string are welded or sewn with the adjacent first spring string are the other one of the first combination positions and the second combination positions.

In the description of this specification, description with reference to the terms “one embodiment”, “some examples”, “some embodiments”, “exemplary embodiments”, “examples”, “specific examples” or “some examples” and the like means that specific features, structures, materials or characteristics described in connection with the embodiment or example are included in at least one embodiment or example of the present disclosure. In this specification, schematic expressions of the above terms do not necessarily refer to the same embodiment or example. Furthermore, the specific features, structures, materials or characteristics described may be combined in any suitable manner in any one or more embodiments or examples.

The embodiments of the present disclosure have been described in detail above in conjunction with the accompanying drawings. However, the present disclosure is not limited to the above embodiments. Within the scope of knowledge possessed by those of ordinary skill in the art, various modifications can be made without departing from the purpose of the present disclosure.

In the description of the present disclosure, if “,” appears in the patent name, it means an “and” relationship, rather than an “or” relationship. For example, the patent name is “A, B”, indicating that the content claimed by the present disclosure is: the technical solution with the subject matter A and the technical solution with the subject matter B.

What is claimed is:

1. A bed mesh combination device, comprising:
a first loading mechanism, wherein the first loading mechanism is configured to transport first spring strings of a set length to a first position in the bed mesh combination device in a first direction parallel to a length direction of a cloth bag of the first spring strings;
a feeding mechanism, wherein the feeding mechanism is configured to transfer the first spring strings from the first position to a second position in the bed mesh combination device, and at the second position, the first spring strings are parallel to the first direction;
a second loading mechanism, wherein the second loading mechanism is configured to transport a second spring string and is capable of reciprocating in the first direction in the bed mesh combination device, so as to continuously arrange the second spring string back and forth in the first direction at the second position, and at the second position, there is one first spring string between two adjacent sections of the second spring string; and
a combination mechanism, wherein the combination mechanism is configured to weld or sew each of the first spring strings at the second position with an adjacent section of the second spring string to form a bed mesh.

2. The bed mesh combination device according to claim 1, wherein the feeding mechanism includes a flipping assembly, the flipping assembly and the combination mechanism are located on the same side of the first loading mechanism, the flipping assembly comprises a flipping frame and a magnetic assembly, the magnetic assembly is arranged on the flipping frame, the flipping assembly is configured to grab a side surface of each of the first spring strings in a magnetic manner and flip around an axis parallel to the first direction, so as to transfer the first spring strings to the second position.

3. The bed mesh combination device according to claim 1, wherein the feeding mechanism comprises a pushing assembly located on the other side of the first loading mechanism, and the pushing assembly is configured to push the first spring strings at the first position in a second direction perpendicular to the first direction.

4. The bed mesh combination device according to claim 1, wherein the bed mesh combination device comprises a cutting mechanism which is arranged on the first loading mechanism, and the cutting mechanism is configured to cut off the first spring strings after the first loading mechanism transports the first spring strings of the set length to the first position.

5. The bed mesh combination device according to claim 4, wherein the cutting mechanism comprises a pressing assembly and a cutter assembly; the pressing assembly comprises two pressing parts which are configured to press each of the first spring strings to be cut at both sides of the respective first spring string, and the cutter assembly comprises a cutter which is movable in a third direction parallel to a length direction of springs in the first spring strings, so as to cut off the cloth bag of the first spring strings.

6. The bed mesh combination device according to claim 1, wherein the loading mechanism comprises an upper conveyor belt and a lower conveyor belt; the first spring strings are transported between the upper conveyor belt and the lower conveyor belt, the upper conveyor belt is configured to abut against upper ends of springs in each of the first spring strings, and the lower conveyor belt is configured to abut against lower ends of the springs in the respective first spring string.

7. The bed mesh combination device according to claim 1, wherein a discharging end of the second loading mechanism is provided with a rotatable toggling part rotatable around an axis parallel to a third direction, at least two toggling grooves are formed in an outer side surface of the toggling part at an interval circumferentially, and the toggling grooves are configured to pull the second spring string in the second direction when the toggling part rotates.

8. The bed mesh combination device according to claim 1, wherein each of the first spring strings and the second spring string has a plurality of first combination positions and a plurality of second combination positions, one of each of the first combination positions and each of the second combination positions is an odd-numbered welding or sewing position, and the other one of each of the first combination positions and each of the second combination positions is an even-numbered welding or sewing position; under the action of the combination mechanism, the first combination positions of a M^{th} first spring string are welded or sewn with the first combination positions of an adjacent section of the second spring string, and the second combination positions of the (M+1)^{th} first spring string are welded or sewn with the second combination positions of an adjacent section of the second spring string, M being a positive integer, or under the action of the combination mechanism, the first combination positions of a N^{th} section of the second spring string are welded or sewn with the first combination positions of the adjacent first spring string, and the second combination positions of a (N+1)^{th} section of the second spring string are welded and sewn with the second combination positions of the adjacent first spring string, N being a positive integer.

9. The bed mesh combination device according to claim 8, wherein the combination mechanism comprises a plurality of first combiners and a plurality of second combiners; the first combiners are arranged as welding cutter assemblies and the second combiners are arranged as welding head assemblies, or the first combiners are arranged as sewing assemblies and the second combiners are arranged as cloth pressing assemblies; the first combiners are divided into two groups, the first combiners in each group are arranged at intervals in the first direction and a spacing between the first combiners is adjustable, and the two groups of first combiners are arranged in a staggered manner in the first direction, with one group of the first combiners being configured for welding or sewing the first combination positions of the first spring strings and the second spring string, and the other group of the first combiners being configured for welding or sewing the second combination positions of the first spring strings and the second spring string.

10. The bed mesh combination device according to claim 9, wherein
the plurality of second combiners are arranged at intervals in the first direction, and the second combiners is capable of reciprocating in the first direction, so as to switch the second combiners to pair with the two groups of first combiners respectively; or, the plurality of second combiners are arranged at intervals in the first direction, and a quantity of the second combiners is equal to a sum of quantities of the two groups of first combiners; and the first combiners are movable up and down in the third direction, and is capable of reciprocating in the second direction to push the combined first spring strings and second spring string out of the second position.

11. The bed mesh combination device according to claim 9, wherein the second combiners are movable up and down in a third direction or the second combiners is capable of being flipped around an axis parallel to the first direction for avoidance when the feeding mechanism arranges the first spring strings or the second loading mechanism arranges the second spring string.

12. A bed mesh combination method, applied to the bed mesh combination device according to claim 8, to combine the first spring strings and the second spring string into a bed mesh, the method comprising:
moving the second loading mechanism in a first direction, so as to arrange the N^{th} section of the second spring string of the set length at the second position;
transporting, by the first loading mechanism, the M^{th} first spring string of the set length to the first position in the first direction, and transferring, by the feeding mechanism, the M^{th} first spring string from the first position to the second position;
moving the second loading mechanism reversely, so as to arrange the (N+1)^{th} section of the second spring string of the set length at the second position, wherein the M^{th} first spring string is located between the N^{th} section of the second spring string and the (N+1)^{th} section of the second spring;
welding or sewing, by the combination mechanism, the first combination positions of the N^{th} section of the second spring string and the first combination positions of the (N+1)^{th} section of the second spring string with the first combination positions of the M^{th} first spring;
transporting, by the first loading mechanism, the (M+1)^{th} first spring string of the set length to the first position in the first direction, and transferring, by the feeding mechanism, the (M+1)^{th} first spring string from the first position to the second position;
moving the second loading mechanism in the first direction, so as to arrange a (N+2)^{th} section of the second spring string of the set length at the second position, wherein the (M+1)^{th} first spring string is located between the (N+1)^{th} section of the second spring string and the (N+2)^{th} section of the second spring; and
welding or sewing, by the combination mechanism, the second combination positions of the (N+1)^{th} section of the second spring string and the second combination positions of the (N+2)^{th} section of the second spring string with the second combination positions of the (M+1)^{th} first spring string; and
wherein the second loading mechanism performs at least one reciprocating motion in the first direction.

13. A bed mesh combination method, applied to the bed mesh combination device according to claim 8, to combine the first spring strings and the second spring string into a bed mesh, the method comprising:
transporting, by the first loading mechanism, the M^{th} first spring string of the set length to the first position in the first direction, and transferring, by the feeding mechanism, the M^{th} first spring string from the first position to the second position;
moving the second loading mechanism in the first direction, so as to arrange the N^{th} section of the second spring string of the set length at the second position;
transporting, by the first loading mechanism, the (M+1)^{th} first spring string of the set length to the first position in the first direction, and transferring, by the feeding mechanism, the (M+1)^{th} first spring string from the first position to the second position, wherein the N^{th} section of the second spring string is located between the M^{th} first spring string and the (M+1)^{th} first spring string;
welding or sewing, by the combination mechanism, the first combination positions of the M^{th} first spring string and the first combination positions of the (M+1)^{th} first spring string with the first combination positions of the N^{th} section of the second spring string;
moving the second loading mechanism reversely, so as to arrange the (N+1)^{th} section of the second spring string of the set length at the second position;
transporting, by the first loading mechanism, a (M+2)^{th} first spring string of the set length to the first position in the first direction, and transferring, by the feeding mechanism, the (M+2)^{th} first spring string from the first position to the second position, wherein the (N+1)^{th} section of the second spring string is located between the (M+1)^{th} first spring string and the (M+2)^{th} first spring string; and
welding or sewing, by the combination mechanism, the second combination positions of the (M+1)^{th} first spring string and the second combination positions of the (M+2)^{th} first spring string with the second combination positions of the (N+1)^{th} section of the second spring string;
wherein the second loading mechanism performs at least one reciprocating motion in the first direction.

14. A bed mesh, manufactured by the bed mesh combination method according to claim 12, wherein the bed mesh comprises the first spring strings and the second spring string, and the second spring string is distributed in an S shape or the second spring string distributed in the S shape are cut into sections with a length identical to the set length of the first spring strings.

15. The bed mesh according to claim 14, wherein a spacing between springs in each of the first spring strings is different from a spacing between springs in the second spring string; and/or, spring strengths in the first spring strings and the second spring string are different.

16. A bed mesh, manufactured by the bed mesh combination method according to claim 13, wherein the bed mesh comprises the first spring strings and the second spring string, and the second spring string is distributed in an S shape or the second spring string distributed in the S shape are cut into sections with a length identical to the set length of the first spring strings.

17. The bed mesh according to claim 16, wherein a spacing between springs in each of the first spring strings is different from a spacing between springs in the second spring string; and/or, spring strengths in the first spring strings and the second spring string are different.
